(19) United States
(12) Patent Application Publication
(10) Pub. No.: US 2008/0204413 A1
(43) Pub. Date: Aug. 28, 2008

(54) OPERATION METHOD OF WIRELESS POINTING INPUT APPARATUS

(75) Inventors: Hsin-Ju Wu, Hsinchu (TW); Hung-Mao Chang, Hsinchu (TW); Hisn-Ling Chu, Hsinchu (TW); Albert Chen, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: INTEGRATED SYSTEM SOLUTION CORP., HSINCHU (TW)

(21) Appl. No.: 11/679,187

(22) Filed: Feb. 27, 2007

(51) Int. Cl. G06F 3/033

(52) U.S. Cl. 345/161; 345/157; 345/163; 345/167; 345/173

(57) ABSTRACT

An operation method of a wireless pointing input apparatus is provided. The operation method includes following steps. The displacement vector of the wireless pointing input apparatus is detected with a resolution. The displacement vector of the wireless pointing input apparatus is transmitted to a host in a wireless way every a time interval. The time interval is decreased correspondingly if the resolution is increased. Or, the time interval is increased correspondingly if the resolution is decreased.

### BACKGROUND OF THE INVENTION

1. Field of the Invention

The present invention relates to a wireless pointing input apparatus. More particularly, the present invention relates to an operation method of a wireless pointing input apparatus.

2. Description of Related Art

When a pointing input apparatus transmits data to a host in a wireless way, in consideration of bandwidth and power consumption, a wireless pointing input apparatus returns data packets to the host at a fixed rate in the conventional technology. For example, in the application of a mouse for a computer, a wireless mouse usually returns data packets of a coordinate displacement to the computer at a fixed rate, so as to show the moving track of the wireless mouse. Currently, an optical (or laser) sensor has various resolutions that can be set. A user can select a favorite resolution with an operating switch or a special button. FIGS. 1A and 1B illustrate moving tracks displayed on a screen with different sensor resolutions when the wireless mouse is moved along a circular track. When the wireless mouse is moved along the circular track, if the sensor of the wireless mouse operates with a low resolution (such as 400 cpi), the moving track displayed on the screen looks small (as shown in FIG. 1A). However, under the precondition that the mouse is moved along the same track at the same rate, when the sensor of the wireless mouse operates with a high resolution (such as 800 cpi), the moving track displayed on the screen looks large (as shown in FIG. 1B). From the aforementioned two drawings, it can be seen that although the large polygon in FIG. 1B is merely an enlarged graphic of the small polygon in FIG. 1A, the large polygon does not look like a circle, because the side length of the large polygons is twice as long as that of the small polygon.

For example, taking the Bluetooth technology as an example, the rate of the mouse transmitting data is not definitely specified in the current Bluetooth standard, but is determined by manufacturers themselves. Generally speaking, a wired USB mouse usually transmits 125 human interface device (HID) packets per second (or one packet per 8 milliseconds), and a Bluetooth wireless mouse operates at a rate lower than 100 HID packets per second for the purpose of saving power. FIG. 2 is a flow chart of a conventional mouse transmitting data packets. When the mouse begins operation, the movement vector of the coordinates of the mouse is obtained (Step S210), and the movement vector is processed into HID packets (Step S220) to be transmitted to a computer (Step S230). In Step S240, the mouse checks whether the user presses a resolution-switching button or not. If the resolution-switching button is pressed, perform Step S250 to set an optical sensor to have a new resolution. The mouse performs Step S260 and pauses the displacement detection and data transmission in a time interval D, and after the time interval D, repeats Steps 210-240. In the conventional technology, all the wired or wireless mice use a fixed transferring rate, which is advantageous in a simple structure. However, the conventional technology adopting a fixed transferring rate may cause a graphic distortion since the moving track is too large in an environment of using a high resolution setting. When the wireless mouse operates with a high resolution setting (i.e., the movement of the mouse generates a large displacement vectors in a fixed time interval), the moving track displayed on the screen cannot truly present the actual moving track of the mouse, thereby causing serious distortion. For example, when the mouse is moved along a circular arc, the moving track displayed on the screen looks like a polygon.

### SUMMARY OF THE INVENTION

The present invention provides an operation method of a wireless pointing input apparatus, such that the wireless pointing input apparatus dynamically adjusts a data transmission according to a resolution. Therefore, the present invention can alleviates the distortion of a moving track in an environment of a high resolution setting, such that when a user is drawing, a graphic very closely like a hand-drawing graphic is displayed on a computer screen. Furthermore, in an environment of a low resolution setting, the data transmission bandwidth can be saved and the power consumption can be reduced.

In order to solve the aforementioned problems, the present invention provides an operation method of a wireless pointing input apparatus, which include the following steps. The displacement vector of the wireless pointing input apparatus is detected with a resolution. The displacement vector of the wireless pointing input apparatus is transmitted to a host in a wireless way every a time interval. The time interval is decreased correspondingly if the resolution is increased. Or, the time interval is increased correspondingly if the resolution is decreased.

The operation method of a wireless pointing input apparatus provided by the present invention can also be described as follows. The operation method of a wireless pointing input apparatus provided by the present invention includes detecting the displacement vector of the wireless pointing input apparatus with a resolution; increasing the transferring rate of the wireless pointing input apparatus transmitting the displacement vector to a host correspondingly if the resolution is increased; and decreasing the transferring rate correspondingly if resolution is decreased.

In the present invention, since the wireless pointing input apparatus dynamically adjusts the time interval of the displacement detection and the data transmission (or dynamically adjusts the data transferring rate) according to the resolution, the present invention can alleviate the distortion of the moving track in an environment of a high resolution setting, such that when a user is drawing, a graphic very closely like a hand-drawing graphic is displayed on a computer screen. On the contrary, in an environment of a low resolution setting, the data transmission bandwidth can be saved and the power consumption can be reduced.

In order to the make aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A and 1B illustrate moving tracks displayed on a screen with different sensor resolutions when the wireless mouse is moved along a circular track.

FIG. 1C illustrate a moving track displayed on the screen with a high sensor resolution when the wireless mouse of the embodiment of the present invention is moved along a circular track.

FIG. 2 is a flow chart of the conventional mouse transmitting data packets.

FIG. 3 is a flow chart of the operation method of the Bluetooth wireless mouse according to an embodiment of the present invention.

FIG. 4 is a flow chart of the operation method of the Bluetooth wireless mouse according to another embodiment of the present invention.

### DESCRIPTION OF EMBODIMENTS

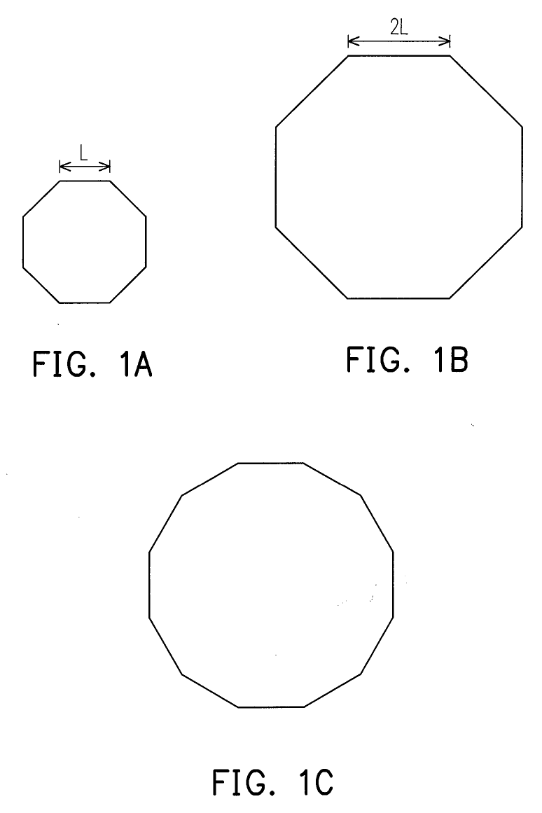

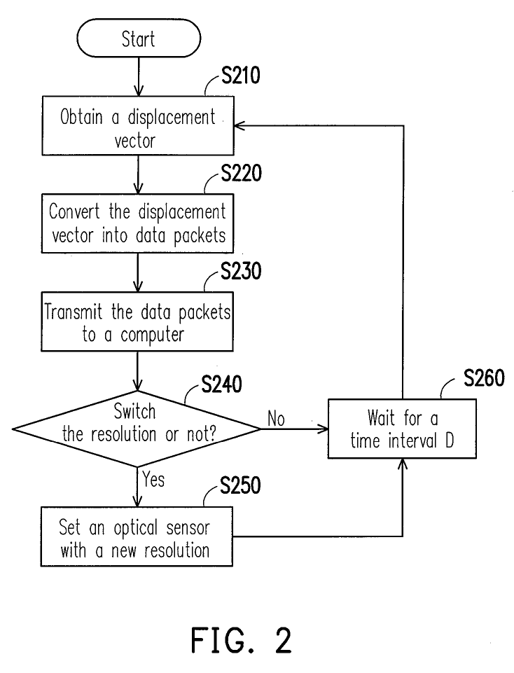

When a wireless pointing input apparatus (such as a wireless mouse, a trackball, a touchpad, and a joystick) is moved along a circular track, if a sensor (such as an optical sensor and a laser sensor) of the wireless pointing input apparatus operates with a low resolution (such as 400 cpi), the moving track displayed on a screen looks small (as shown in FIG. 1A). However, under the precondition that the wireless pointing input apparatus is moved along the same track at the same rate, when the sensor of the wireless pointing input apparatus operates with a high resolution (such as 800 cpi), the moving track displayed on the screen looks large (as shown in FIG. 1B). From the aforementioned two drawings, it can be seen that although the large polygon in FIG. 1B is merely an enlarged graphic of the small polygon in FIG. 1A, the large polygon does not look like a circle, because the side length of the large polygons is twice as long as that of the small polygon. Therefore, when the sensor of the wireless pointing input apparatus operates with a high resolution, if the wireless pointing input apparatus transmits data packets to a host (such as a computer) at a high transferring rate, the host receives more data in unit time, such that the graphic displayed on the screen looks smoother (i.e., the side length of the polygon is shorter, as shown in FIG. 1C).

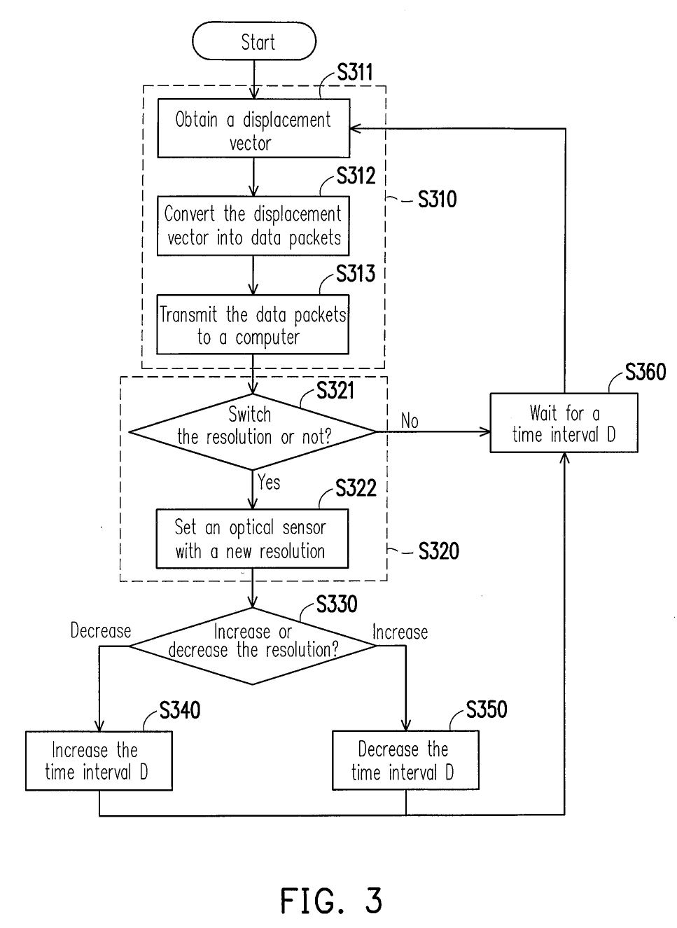

Persons of ordinary skill in the art may implement the present invention in various wireless pointing input apparatuses according to the spirits of the present invention and the suggestions and teaching of the following embodiments. In order to clearly illustrate the embodiments of the present invention, a Bluetooth wireless mouse is taken as an example below. FIG. 3 is a flow chart of the operation method of the Bluetooth wireless mouse according to an embodiment of the present invention. In this embodiment, the Bluetooth wireless mouse performs Step S310 to detect a displacement vector of a wireless pointing input apparatus (such as the Bluetooth wireless mouse) with a resolution. In Step S320, a mechanism of switching the resolution of the Bluetooth wireless mouse is provided. If the resolution of the Bluetooth wireless mouse has not been changed, the Bluetooth wireless mouse performs displacement detection and data transmission (Step S310) every a time interval D (Step S360), so as to transmitting the displacement vector of the Bluetooth wireless mouse to the host (such as a computer, a PDA, and a mobile phone) in a wireless way (such as radio frequency (RF) transmission and Bluetooth transmission).

If the resolution of the Bluetooth wireless mouse has been changed, perform Step S330 to determine whether the resolution is increased or decreased. If the resolution of the Bluetooth wireless mouse is increased, the time interval D is decreased correspondingly (Step S350). If the resolution of the Bluetooth wireless mouse is decreased, the time interval D is increased correspondingly (Step S340). In this embodiment, if the determination result in Step S330 is that the resolution is increased, the Bluetooth wireless mouse increases the transferring rate at which the displacement vector is transmitted to the computer correspondingly. If the determination result in Step S330 is that the resolution is decreased, the transferring rate is decreased correspondingly.

In this embodiment, Step S310 includes Step S311-S313. In Step S311, the displacement vector of the Bluetooth wireless mouse is detected by the sensor (such as an optical sensor and a laser sensor) with a resolution. After the displacement vector is obtained, the Bluetooth wireless mouse converts the displacement vector into data packets (Step S312), and transmits the data packets to the computer in a wireless way (Step S313).

In this embodiment, Step S320 includes Steps S321 and S322. In Step S321, the Bluetooth wireless mouse checks whether the resolution is switched by the user, i.e., whether the user ever performs the resolution switching action, for example, whether the user presses a “resolution-switching button”. If the resolution has not been switched by the user, perform Step S360. If the resolution has been switched by the user, perform Step S322 to set the sensor with a new resolution. If the new resolution after switching is higher than the original resolution, the Bluetooth wireless mouse decreases the time interval D correspondingly (Step S350). If the new resolution after switching is lower than the original resolution, the Bluetooth wireless mouse increases the time interval D correspondingly (Step S340). In this embodiment, if the new resolution after switching is higher than the original resolution, the transferring rate at which the displacement vector is transmitted to the computer is increased correspondingly. If the new resolution after the switching is lower than the original resolution, the transferring rate is decreased correspondingly.

Therefore, when the Bluetooth wireless mouse moves along the circular track, if the sensor of the Bluetooth wireless mouse operates with a low resolution (such as 400 cpi), the moving track displayed on the screen looks small (as shown in FIG. 1A). Under the precondition that the Bluetooth wireless mouse is moved along the same track at the same rate, when the sensor of the Bluetooth wireless mouse operates with a high resolution (such as 800 cpi), since the Bluetooth wireless mouse transmits the data packets to the computer at a high transferring rate (or decreases the time interval D of performing displacement detection and data transmission), the computer receives more data in unit time, such that the graphic displayed on the screen looks smoother (i.e., the side length of the polygon becomes short, as shown in FIG. 1C). In the aforementioned embodiment, since the Bluetooth wireless mouse dynamically adjusts the time interval D of the displacement detection and the data transmission (or dynamically adjusts the data transferring rate) according to the resolution, the distortion of the moving track is alleviated in an environment of a high resolution setting, such that, when a user is drawing, a graphic very closely like a hand-drawing graphic is displayed on the computer screen. On the contrary, in an environment of a low resolution setting, the time interval D of the displacement detection and the data transmission can be dynamically increased (or the data transferring rate is dynamically reduced), so as to save a wireless transmission bandwidth and reduce power consumption.

If the sensor of the Bluetooth wireless mouse has more than two resolution settings, there are also more than two time intervals D of the displacement detection and the data transmission that are dynamically adjusted by the Bluetooth wireless mouse according to the resolution. However, the present invention is not limited to that two resolutions correspond to two time intervals D.

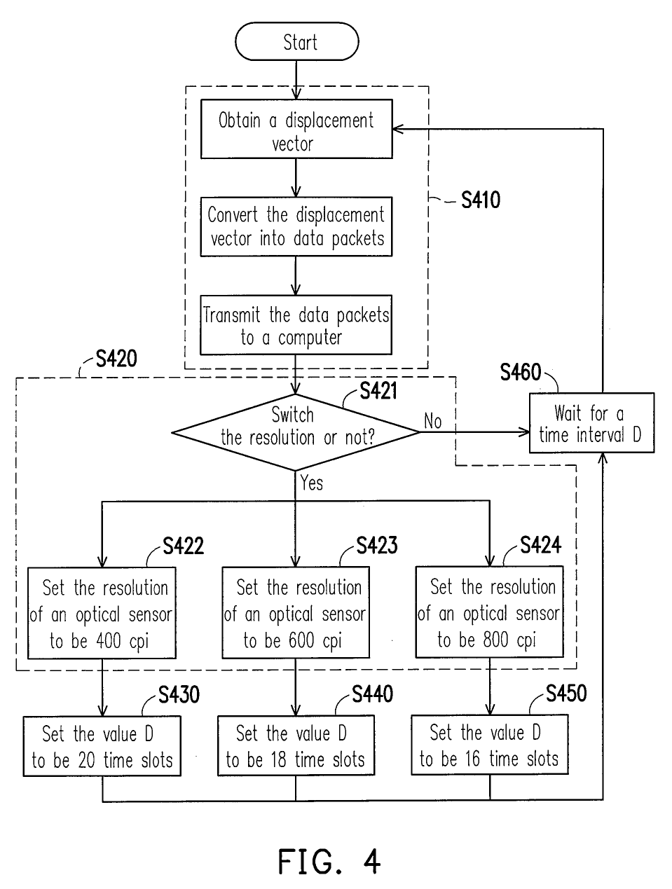

FIG. 4 is a flow chart of the operation method of the Bluetooth wireless mouse according to another embodiment of the present invention. In Step S410, the Bluetooth wireless mouse detects the displacement vector of the Bluetooth wireless mouse by a sensor (such as an optical sensor and a laser sensor) with a resolution. After the displacement is obtained, the Bluetooth wireless mouse converts the displacement vector into data packets, and transmits the data packets to a host (such as a computer) in a wireless way (such as RF transmission and Bluetooth transmission). In Step S420, a mechanism of switching the resolution of the Bluetooth wireless mouse is provided. If the resolution of the Bluetooth wireless mouse has not been changed, the Bluetooth wireless mouse performs the displacement detection and the data transmission (Step S410) every a time interval D (Step S460), such that the displacement vector of the Bluetooth wireless mouse is transmitted to the host (such as a computer) in a wireless way. In this embodiment, Steps S410 and S460 can be implemented with reference to Steps S310 and S360 in FIG. 3, and the details will not be described herein again.

In this embodiment, Step S420 includes Steps S421, S422, S423, and S424. In Step S421, the Bluetooth wireless mouse checks whether the resolution is switched by the user, i.e., whether the user ever performs the resolution switching action, for example, whether the user presses the “resolution-switching button”. If the resolution has not been changed by the user, perform Step S460 and maintain the time interval D that is set before. If the resolution has been changed by the user, perform one of Steps S422, S423, and S424 according to the selection of the user. If the user selects the resolution of 400 cpi, perform Step S422 to set the resolution of the sensor to be 400 cpi. If the user selects the resolution of 600 cpi, perform Step S423 to set the resolution of the sensor to be 600 cpi. If the user selects the resolution of 800 cpi, perform Step S424 to set the resolution of the sensor to be 800 cpi.

According to the Bluetooth wireless protocol, when the operation is performed in a sniff mode, the sniff interval D between two data packets uses a time slot as the unit. One time slot is 0.625 milliseconds. If the resolution of the sensor is set to be 400 cpi, perform Step S430 to set the sniff interval D to be 20 time slots (12.5 milliseconds). If the resolution of the sensor is set to be 600 cpi, perform Step S440 to set the sniff interval D to be 18 slots (11.25 milliseconds). If the resolution of the sensor is set to be 800 cpi, perform Step S450 to set the sniff interval D to be 16 slots (10 milliseconds). In other words, if the new resolution after switching is higher than the original resolution, the Bluetooth wireless mouse reduces the sniff interval D correspondingly; and if the new resolution after switching is lower than the original resolution, the Bluetooth wireless mouse increases the sniff interval D correspondingly. In this embodiment, if the new resolution after switching is higher than the original resolution, the transferring rate at which the displacement vector is transmitted to the computer is increased correspondingly. After the sniff interval D is adjusted (Steps S430-S450), the Bluetooth wireless mouse performs the displacement detection and the data transmission (Step S410) every a new sniff interval D (Step S460), so as to transmit the displacement vector of the Bluetooth wireless mouse to the host in a wireless way.

In the aforementioned embodiment, since the Bluetooth wireless mouse dynamically adjusts the time interval D of the displacement detection and the data transmission (or dynamically adjusts the data transferring rate) according to the sensor resolution, the distortion of the moving track is alleviated in an environment of a high resolution setting, such that when a user is drawing, a graphic very closely like a hand-drawing graphic is displayed on the computer screen. On the contrary, in an environment of a low resolution setting, the time interval D of the displacement detection and the data transmission can be dynamically increased (or the data transferring rate is dynamically reduced), so as to save a wireless transmission bandwidth and reduce power consumption.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An operation method of a wireless pointing input apparatus, comprising:
detecting a displacement vector of the wireless pointing input apparatus with a resolution;
transmitting the displacement vector of the wireless pointing input apparatus to a host in a wireless way every a time interval;
decreasing the time interval correspondingly if the resolution is increased; and
increasing the time interval correspondingly if the resolution is decreased.

2. The operation method of a wireless pointing input apparatus as claimed in claim 1, wherein the step of transmitting the displacement vector to a host comprises:
converting the displacement vector into data packets; and
transmitting the data packets to the host in the wireless way.

3. The operation method of a wireless pointing input apparatus as claimed in claim 1, further comprising:
detecting whether the resolution is switched or not;
wherein the time interval is decreased correspondingly if a new resolution after switching is higher than the original resolution; and the time interval is increased correspondingly if the new resolution after switching is lower than the original resolution.

4. The operation method of a wireless pointing input apparatus as claimed in claim 1, wherein the wireless way comprises Bluetooth transmission.

5. The operation method of a wireless pointing input apparatus as claimed in claim 1, wherein the wireless way comprises radio frequency (RF) transmission.

6. The operation method of a wireless pointing input apparatus as claimed in claim 1, wherein the wireless pointing input apparatus comprises a wireless mouse.

7. The operation method of a wireless pointing input apparatus as claimed in claim 1, wherein the wireless pointing input apparatus comprises a wireless touchpad.

8. The operation method of a wireless pointing input apparatus as claimed in claim 1, wherein the wireless pointing input apparatus comprises a wireless trackball.

9. The operation method of a wireless pointing input apparatus as claimed in claim 1, wherein the wireless pointing input apparatus comprises a wireless joystick.

10. The operation method of a wireless pointing input apparatus as claimed in claim 1, wherein the host comprises a computer.

11. The operation method of a wireless pointing input apparatus as claimed in claim 1, wherein the host comprises a personal digital assistant (PDA).

12. The operation method of a wireless pointing input apparatus as claimed in claim 1, wherein the host comprises a mobile phone.

13. An operation method of a wireless pointing input apparatus, comprising:
detecting the displacement vector of the wireless pointing input apparatus with a resolution;
increasing the transferring rate of the wireless pointing input apparatus transmitting the displacement vector to a host correspondingly if the resolution is increased; and
decreasing the transferring rate correspondingly if resolution is decreased.

14. An operation method of a wireless pointing input apparatus as claimed in claim 13, further comprising:
converting the displacement vector into data packets; and
transmitting the data packets to the host in a wireless way.

15. The operation method of a wireless pointing input apparatus as claimed in claim 14, wherein the wireless way comprises Bluetooth transmission.

16. The operation method of a wireless pointing input apparatus as claimed in claim 14, wherein the wireless way comprises RF transmission.

17. The operation method of a wireless pointing input apparatus as claimed in claim 13, further comprising:
detecting whether the resolution is switched or not;
wherein the time interval is decreased correspondingly if a new resolution after switching is higher than the original resolution; and the time interval is increased correspondingly if the new resolution after switching is lower than the original resolution.

18. The operation method of a wireless pointing input apparatus as claimed in claim 13, wherein the wireless pointing input apparatus comprises a wireless mouse.

19. The operation method of a wireless pointing input apparatus as claimed in claim 13, wherein the wireless pointing input apparatus comprises a wireless touchpad.

20. The operation method of a wireless pointing input apparatus as claimed in claim 13, wherein the wireless pointing input apparatus comprises a wireless trackball.

21. The operation method of a wireless pointing input apparatus as claimed in claim 13, wherein the wireless pointing input apparatus comprises a wireless joystick.

22. The operation method of a wireless pointing input apparatus as claimed in claim 13, wherein the host comprises a computer.

23. The operation method of a wireless pointing input apparatus as claimed in claim 13, wherein the host comprises a personal digital assistant (PDA).

24. The operation method of a wireless pointing input apparatus as claimed in claim 13, wherein the host comprises a mobile phone.
